(19) United States
(12) Patent Application Publication
(10) Pub. No.: US 2010/0235727 A1
(43) Pub. Date: Sep. 16, 2010

(54) Systems and Methods for Dynamic Electronic Signature Placement

(76) Inventors: Brian G. Ashton, West Valley City, UT (US); Vaughn E. Silcox, Midvale, UT (US); Scott Buchanan, Salt Lake City, UT (US); Josue Arceo, Salt Lake City, UT (US); Kendall Buchanan, Spanish Fork, UT (US)

Correspondence Address: Michael F. Krieger;Kirton & McConkie, 60 East South Temple, Suite 1800, Salt Lake City, UT, 84111, US

(21) Appl. No.: 12/724,218

(22) Filed: Mar. 15, 2010

Related U.S. Application Data
(60) Provisional application No. 61/160,305, filed on Mar. 14, 2009.

(51) Int. Cl. G06F 17/00

(52) U.S. Cl. 715/253

(57) ABSTRACT

Systems and methods for ensuring proper placement of electronic signatures in dynamic electronically-signed documents where the signature location of the documents may change based on changes of terms within the documents are described. The documents are dynamic or variable documents in that the text and signature line or lines of the documents move based on the document terms, number of signatories, etc. Computers and computer programs are used to scan through a dynamic document and determine where to print signatures when signatories log into an electronic signing room and elect to sign a given document. Information about a document is gathered from an electronic version of the document to locate signature lines and initials lines. Information regarding the locations of all signature and initials lines is then passed with the document for electronic signature. When the document is electronically signed, the electronic signature images are therefore placed in correct locations.

### CROSS-REFERENCE TO RELATED APPLICATIONS

This application claims the benefit of U.S. Provisional Application No. 61/160,305, filed Mar. 14, 2009.

### BACKGROUND OF THE INVENTION

1. Field of the Invention

The present invention relates to electronic signatures in electronic documents and, more particularly, to systems and methods that ensure proper placement of electronic signatures in dynamic electronically-signed documents where the signature location changes based on changes of terms within the documents.

2. Background and Related Art

Signatures have been used for centuries to notarize and authenticate documents. A person's signature can give evidence of the provenance of a document as well as the intention of the person with regard to that document. For example, the role of a signature in many consumer contracts is not solely to provide evidence of the identity of the contracting party, but rather to additionally provide evidence of deliberation and informed consent. The unique properties of a person's signature have enabled their use as a legally binding indication that signing individuals, or signatories, understand and consent to documents containing their signature.

With the advent of the digital age, a replacement for a person's handwritten signature has long been sought; however suitable electronic substitute for the signature has been difficult to provide. The lack of a suitable electronic signature has been particularly problematic with respect to certain documents having variable terms for certain reasons. With respect to such documents, as the terms of the documents are changed, the location or locations where the document is to be signed is commonly changed. This is not a problem with respect to physical handwritten signatures, as the signatory or signatories merely notes the proper location for signature and signs at the designated location.

In the realm of electronic signatures, however, existing electronic signature methods fail to adequately deal with a variable signature location. For example, a mortgage loan document (or any other number of documents) may have certain terms that will be included in the document or excluded from the document as the terms of the document are negotiated by the parties. Furthermore, a mortgage loan document used by a bank with respect to party A will have different terms than a similar document used by the bank with respect to party B. The addition or removal of terms, the addition, removal, or change of the total number of signing parties, and many other differences or changes cause the documents to have differing numbers of total pages, differing physical locations for signature within one or more pages, and other changes that make it difficult to use a single electronic signature location across a wide variety of documents.

For example, consider a static signature location: if an electronic signature location is designated at location X of page Y for all documents, an electronic signature is to be inserted into the document at that location for all documents. This static location may require several blank pages in some documents and may be located in the middle of document text for other documents. Thus, the use of a static signature location for electronic signing of documents fails to satisfactorily provide an electronic signature solution.

The problems with electronic signatures are further compounded by the importance of maintaining electronic documents and verifying electronic signatures. It is important to ensure that electronically-stored documents are signed and stored in such a way as to ensure their continued validity in the event of disputes regarding the documents, their contents, and the signatures of the parties to the documents. For example, the Mortgage Electronic Registration System (MERS®) has been created to track the mortgage ownership and servicing rights including when they are originated and sold. Therefore, it is important that electronic signatures occur in a way as to ensure their validity and the validity of the underlying document after storage for an indeterminate amount of time and possibly the transfer of the electronically-signed documents between parties.

### BRIEF SUMMARY OF THE INVENTION

Implementation of the invention provides systems and methods for ensuring proper placement of electronic signatures in dynamic electronically-signed documents where the signature location of the documents may change based on changes of terms within the documents. The documents are dynamic or variable documents in that the text and signature line or lines of the documents move based on the document terms, number of signatories, etc. Implementation of the invention may be used with any type of document where one or more signatures is needed. Examples of such documents include various types of loans such as real property loans (e.g. mortgages), vehicle loans, education loans, signature loans, etc., applications (e.g. educational/school applications, job/employment applications, etc.) and various other types of contracts between parties or other documents requiring signatures.

Implementation of the invention occurs in conjunction with one or more computers (including networked computers) and computer programs that scan through a dynamic document and determine where to print signatures when signatories log into an electronic signing room and elect to sign a given document. A process is implemented whereby information about a document is gathered from an electronic version (e.g. portable document format (PDF), etc.) of the document. In this process, each page of the document is scanned to locate signature lines and initials lines. Information regarding the locations of all signature lines and initials lines is then passed with the document to a signature room where the document may be electronically signed. When the document is electronically signed, the signature location information (including the initials location information) is used to properly locate electronic signature images in correct locations within the dynamic document, which locations are the locations previously determined by scanning the document.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative computer system configuration for use with embodiments of the present invention;

FIG. 2 shows a representative networked computer system configuration for use with embodiments of the present invention;

FIG. 3 shows a flowchart depicting a process in accordance with embodiments of the present invention;

FIG. 4 shows a flowchart depicting a process in accordance with embodiments of the present invention; and

FIG. 5 shows a depiction of interactions that may take place during preparation, revision, and electronic signing of an electronic document.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide systems and methods for ensuring proper placement of electronic signatures in dynamic electronically-signed documents where the signature location of the documents may change based on changes of terms within the documents. The documents are dynamic or variable documents in that the text and signature line or lines of the documents move based on the document terms, number of signatories, etc. Embodiments of the invention may be used with any type of document where one or more signatures is needed. Examples of such documents include various types of loans such as real property loans (e.g. mortgages), vehicle loans, education loans, signature loans, etc., applications (e.g. educational/school applications, job/employment applications, etc.) and various other types of contracts between parties or other documents requiring signatures.

Embodiments of the invention utilize one or more computers (including networked computers) and computer programs that scan through a dynamic document and determine where to print signatures when signatories log into an electronic signing room and elect to sign a given document. A process is implemented whereby information about a document is gathered from an electronic version (e.g. portable document format (PDF), etc.) of the document: each page of the document is parsed or scanned to locate signature lines and initials lines. Information regarding the locations of all signature lines and initials lines is then passed with the document to a signature room where the document may be electronically signed. When the document is electronically signed, the signature location information (including the initials location information) is used to properly place the electronic signature images in correct locations within the dynamic document, which locations are the locations previously determined by scanning the document.

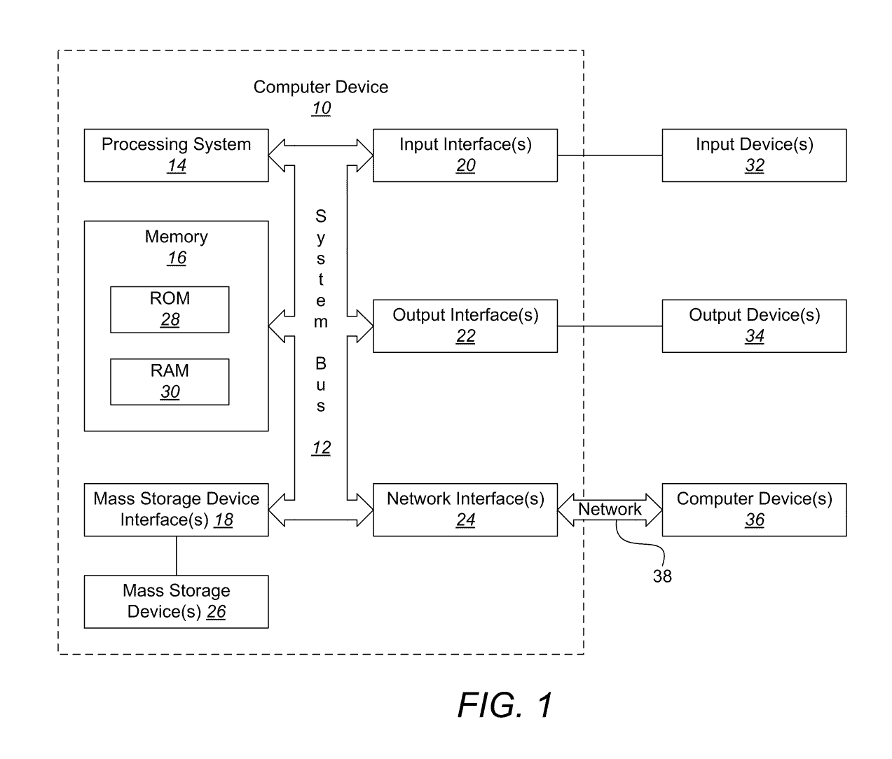

As embodiments of the invention utilize computers and computer programs, FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing embodiments of the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

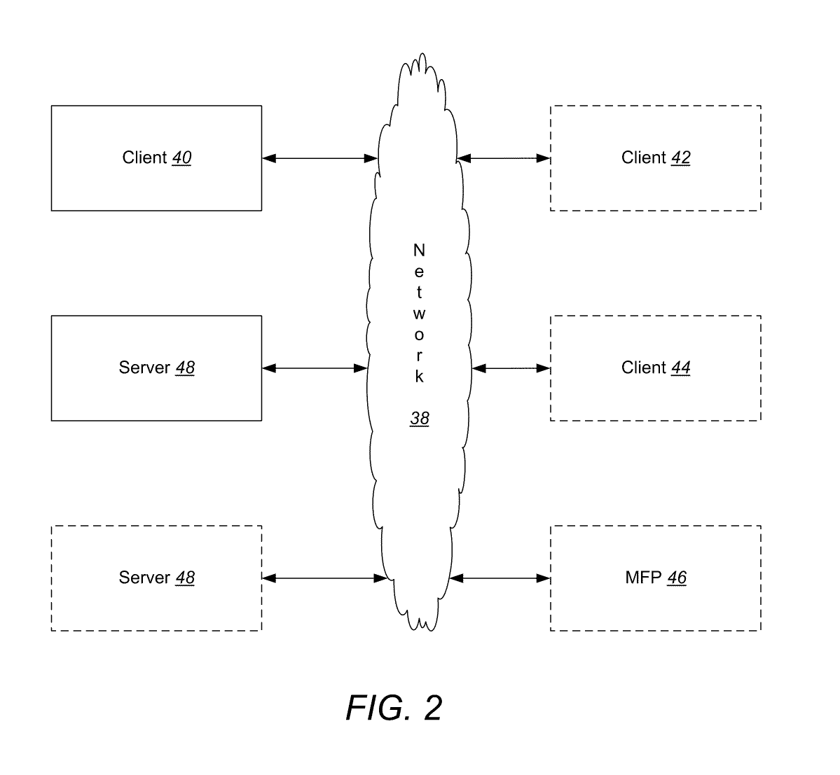

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, a server 48 and an additional optional server 48, connected to network 38, alternative embodiments include more or fewer clients, more than one peripheral device, no peripheral devices, no server 48, and/or multiple servers 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

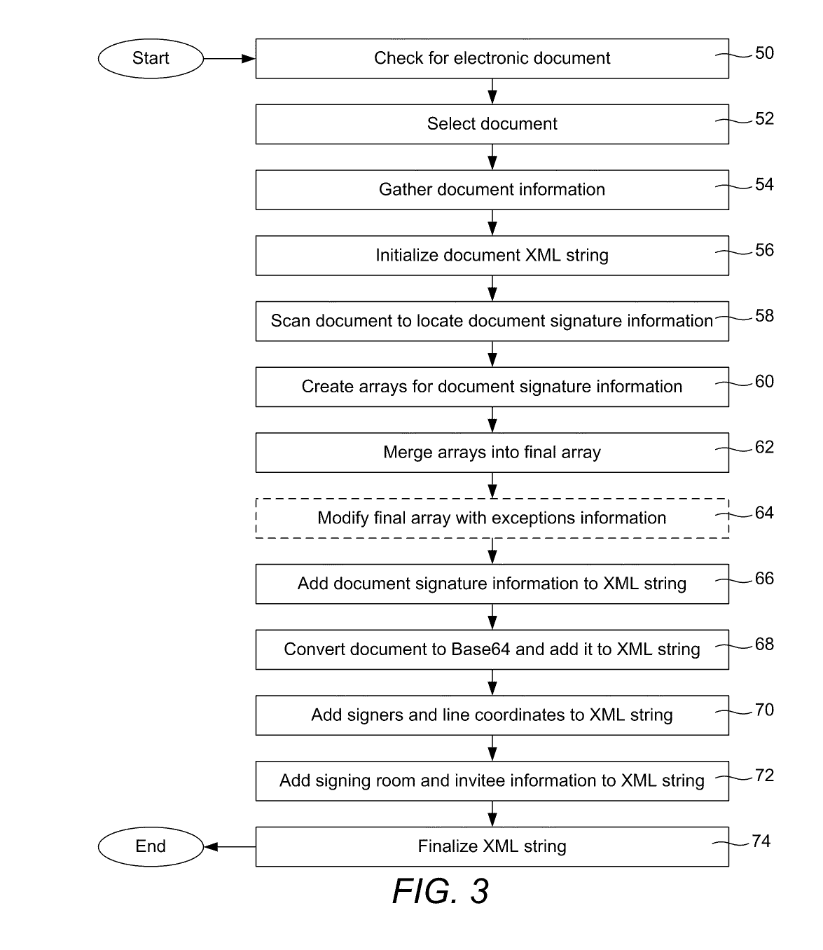

Embodiments of the invention permit correct electronic signature localization on dynamic documents where the signature location or locations vary as terms of the dynamic documents change. FIG. 3 illustrates a representative process for providing correct localization of a signature location. Execution begins at step 50, where a check for electronic (e.g. PDF) documents that are waiting to be parsed or scanned to locate signature locations is performed. The electronic documents are commonly generated by an external program that generates the documents. For example, a loan preparation program may prepare electronic mortgage documents based on standard mortgage terms and additional contract terms that have been agreed-upon by the parties to the mortgage. As the terms vary from mortgage to mortgage based on a variety of factors, including the lender, the names and numbers of borrowers, the security, down payment, etc., the locations for signatures within the generated electronic documents vary from document to document. The process of FIG. 3 ensures that when the documents are electronically signed, the electronic signature (or signatures) is placed in the proper signature locations, thus transforming an unsigned dynamic digital document first into a digital document having one or more known locations for one or more electronic signatures and then into a signed digital document with electronic signatures properly located within the document.

When one or more electronic document is located at step 50, execution proceeds to step 52, where one of the electronic documents is selected for processing. Information about the electronic document is gathered at step 54. Such information can include a document type, number of pages, or any other information relevant to processing the document. At step 56, an Extensible Markup Language (XML) string for the electronic document is initialized. In the illustrated embodiment, the XML string serves to encode the document and information regarding the dynamic signature location or locations within the document. In other embodiments, other languages or encoding mechanisms may be used. At step 58, the electronic document is scanned or parsed to obtain document signature information.

Document signature information may be located by one or more of a variety of methods. For example, the signature information may be located by recognizing signature and/or initials lines according to pre-defined recognition rules, such as a horizontally-placed line at one of several commonly-used locations. Such locations may include, for example, at the top or bottom of a page or at the top or bottom of a paragraph of text. Other possible recognition keys or mechanisms include a horizontal line having a set of words underneath, before, or after it. Alternatively, the process may recognize key words commonly associated with a signature and/or initials line or location, such as “initials,” “signature,” “lender,” “borrower,” etc., either associated with a line, associated with a white space, or otherwise recognizable/detectable as a signature location. As still another alternative, the document may include one or more invisible characters at each signing location that are recognized by the scanning/parsing process and that serve to identify and provide the signature information. The foregoing list of options is intended to be illustrative of the wide variety of options that may be used as the document is scanned or parsed to obtain document signature information. Thus, correct document signature information is obtained to locate proper placement of electronic signatures regardless of any movement of signature locations that occurs as the dynamic document is changed.

The document signature information that is obtained may include, for example, a document name (such as for an exception document), one or more signature lines, and one or more initials lines. This information is placed into an information array for each type of information at step 60. The information stored in the arrays may include, for example, a document name (if relevant), a page number, coordinates, and a signature type for each signature or initials line. The signature line information is placed in a signature line information array, the initials line information is placed in an initials line information array, and the exception information is placed in an exception information array. At step 62, a final array of information is created from the signature line information array and the initials line information array, and the final array is modified at step 64 with any changes specified by the exception information array (if any). The document signature information from the final array (as modified) is then added to the XML string at step 66.

Execution proceeds to step 68, where the electronic document is converted to Base 64 and is then also added to the XML string. This conversion permits ready transfer of the document and additional information between parties in a readily-compatible format, and it is anticipated that other formats can be used or that in some embodiments no conversion of the electronic document occurs. The signers and their respective signature line coordinates and/or initials line coordinates for each page are also added to the XML string at step 70. At step 72, information relating to the signing of the electronic document is added, such as signing room information and invitee information. This information permits proper delivery of the document and signature information to a secure signing room (or the like) where only the proper invited signatories are able to view and sign the electronic document. The XML string is thereafter finalized at step 74.

After finalization, the XML string includes all information for the electronic document, signatory information, as well as the signing coordinates for the various signatories and signing locations in a single portable format. Although the steps shown in FIG. 3 have been shown in a particular order, it is anticipated that at least some of the steps may be provided in a different order or may occur essentially simultaneously with other steps. Therefore, the order shown in FIG. 3 is not intended to be limiting, but is merely illustrative of one embodiment of the invention. In the finalized format, the XML string representation of the document can be delivered to a wide variety of electronic signature service providers (which may or may not be the same party providing the dynamic documents with defined signature locations) that attend to obtaining and verifying the signatories' signatures and any further processing and storing of the electronically-signed document.

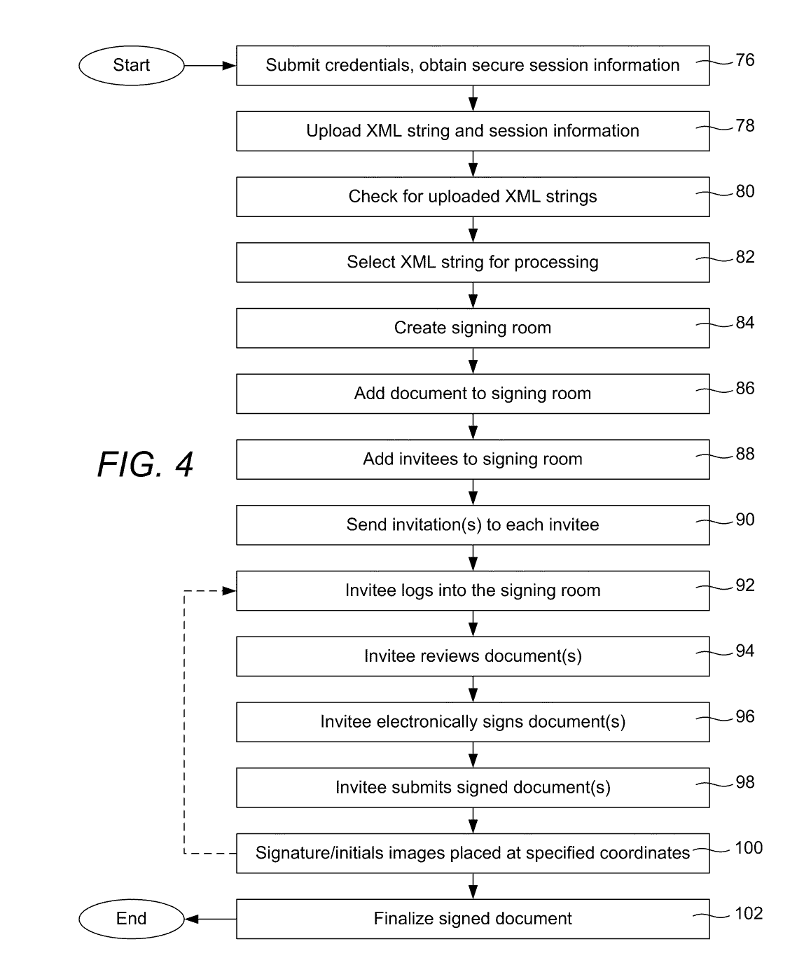

For example, FIG. 4 depicts one representative process for providing a secure setting for electronic signature of the document and ensuring that the documents are tamper-proof once signed. Execution begins at step 76, where the document preparer submits credentials to the electronic signature service provider (if the provider and the preparer are different entities) and obtains secure session information (such as an access code, session ID, etc.). At step 78, the document preparer uploads the XML string generated from a process such as that shown in FIG. 3 to the electronic signature service provider along with the session information for verification.

The electronic signature service provider checks for uploaded XML strings at step 80 and selects an XML string for processing at step 82. The service provider then utilizes the signing room information in the XML string to create a signing room at step 84, and adds the converted electronic document to the signing room at step 86. Execution then proceeds to step 88, where the service provider also adds invitees (e.g. the signatories) to the signing room. Once the signing room is prepared with the document as well as the proper invitees, the service provider then sends an invitation to each invitee to visit the signing room at step 90. The invitations may be made by various means, including electronic and non-electronic mechanisms such as electronic mail, text message, postal mail, telephone call, or using any other contact information or method desired by the service provider or invitee. Where electronic mechanisms are used for the invitation, the invitation may include a link to the signing room. Whatever method is used may include instructions for logging into the signing room, reviewing the document or documents, and electronically signing the document or documents.

Each invitee logs into the signing room at step 92 and reviews the document or documents at step 94. Not all invitees who have been invited to review each document need necessarily be potential signatories to the document, but if the invitee is a potential signatory, the invitee electively electronically signs each document by clicking “OK” or some other identifier as prompted at each signature line and initials line for that signatory in that document at step 96. Thereafter, the invitee who is a signatory submits each signed document at step 98, and signature images and/or initials images are placed at the coordinates specified on each page at step 100. As may be appreciated, steps 92 through 100 are repeated for each signatory of each document until all signatories have electronically signed each document, whereupon the service provider finalizes the document into a final merged and tamper-proof document and stored until needed. As with the processes illustrated with respect to FIG. 3, the process steps and the particular order illustrated with respect to FIG. 4 may occur in an order different than the order specifically shown in FIG. 4, and some of the steps may occur simultaneously or essentially simultaneously.

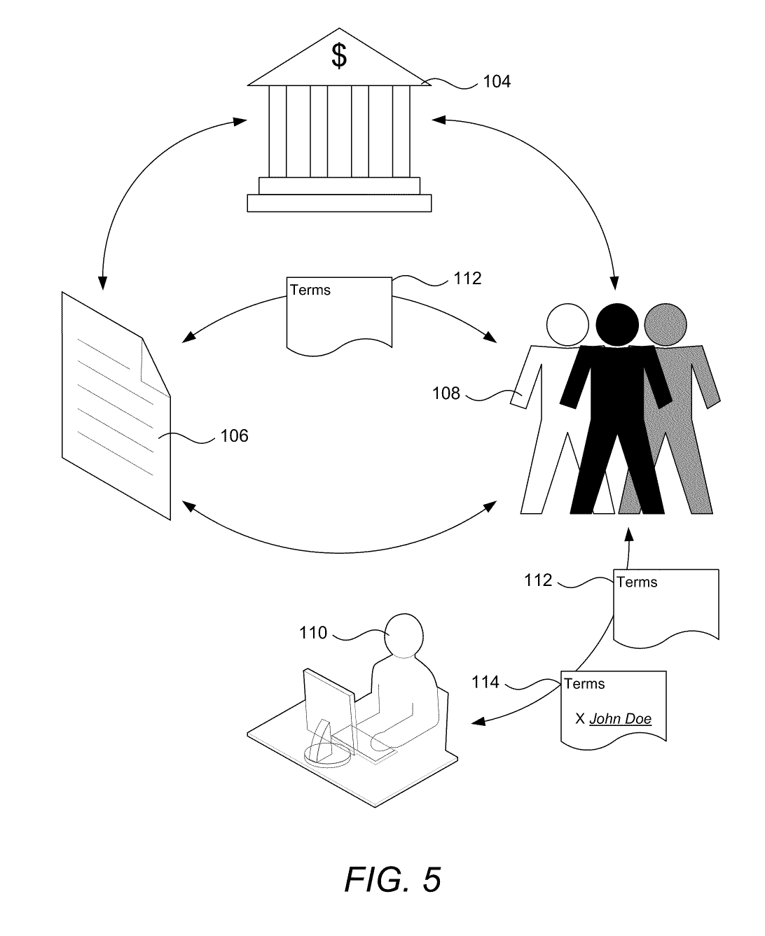

To illustrate the complexity of the signing process that may occur in even a simple mortgage document, FIG. 5 illustrates some of the lines of communication and processes that may occur as a mortgage document is generated, prepared for electronic signature, reviewed, revised, and electronically signed. In the illustrated example shown in FIG. 5, at least four parties are involved, namely, a lender 104, a document preparer 106, an electronic signature service provider 108, and a borrower 110. It should be understood that in some instances one or more of the parties illustrated in FIG. 5 may actually be departments within a single party or service provider, or may be a single entity or provider. For example, the document preparer 106 and the service provider 110 may be combined in some instances as a single entity. In other instances, the lender 104 may prepare its own documents, thereby also acting as document preparer 106. These examples are meant only to be illustrative and other examples are envisioned.

When a loan process is begun, the lender 104 may enter into communication with the document preparer 106, asking the document preparer to prepare a loan document 112 for a loan to be extended from the lender 104 to the borrower 110. The document preparer 106 prepares the loan document 112 according to the terms specified by the lender 104, which may be terms agreed to by the borrower 110. The document preparation process includes processes such as those illustrated in FIG. 3, and the document preparer 106 provides the prepared loan document 112 to the service provider 108, as discussed with respect to FIG. 4. The service provider 108 works with the loan document 112 and with the borrower 110 to get the loan document 112 electronically signed by the borrower 110 as discussed with respect to FIG. 4. This includes providing the borrower 110 with the loan document 112 for review and electronic signature, such as over the Internet.

Suppose, however, that upon reviewing the loan document 112, the borrower 110 determines that the terms memorialized in the loan document 112 are not fully acceptable for whatever reason. The borrower 110 then, instead of electronically signing the loan document 112, contacts either the service provider 108 or the lender 104 to notify of the unacceptable terms. If the terms are unacceptable and the loan is to proceed, the terms of the loan document 112 must be modified. This may involve communication between the lender 104 and the document preparer 106, between the service provider 108 and the document preparer 106, between the service provider 108 and the lender 104, and/or between the borrower 110 and the service provider 108 or the lender 104. The changes in the terms of the loan document 112 may cause the location of the signature lines and/or initials lines within the loan document 112 to change in many ways, but because the processes for locating the signature/initials lines and ensuring proper placement of electronic signatures at those locations can be rapidly repeated as the dynamic loan document 112 is changed, the process ensures that when the loan document is eventually in a proper form and is electronically signed by the borrower to become an electronically-signed document 114, the electronic signature images are placed in the proper (new) locations within the electronically-signed document 114. This occurs regardless of the changes that may have been made in the document, including the addition of additional signature and/or initials lines or the deletion of one or more signature and/or initials lines.

As may be appreciated, the review process, number of changes within the document, and possible need to re-locate the signature lines and/or initials lines can be further complicated as the number of parties to the document and the number of signatories increases. While FIG. 5 illustrates a process in conjunction with a loan document, it should be appreciated that embodiments of the invention can be used with any type of process where documents require signature, as discussed herein.

As another illustration of advantages obtained by embodiments of the invention, some embodiments enable dynamic placement of electronic signatures within a document in an order in which a document is signed. For example, if multiple parties are to sign a document, but it is unknown in what order the parties will review and sign the document, it may be advantageous to dynamically place the electronic signatures of the various signatories in the document in the order in which the signatories signed the document. This process may occur in real time as the document is signed.

Thus, the proper placement and locations with respect to individual electronic signatures of a particular party may change depending on the order in which the signatories access and electronically sign the document. In such an instance, the signature locations for each party may change while the document is in the process of being electronically signed by the parties, but the embodiments of the invention are capable of ensuring that all signatures are properly placed in the document, as the signature locations are dynamically varied as each signatory signs the document. To achieve proper placement, the various signature locations may initially be located but not assigned to a particular signatory until the point of signing, or the locations may be assigned to particular signatories but are rearranged as the document is electronically signed by one party and then another.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A method for ensuring proper placement of electronic signatures in a dynamic electronically-signed document where the placement of one or more signatures in the document changes based on changes of terms within the document comprising:
creating a dynamic electronic document having variable document contents, the document including a signature location;
scanning the dynamic electronic document to locate document signature information representing a location where the dynamic electronic document is to be electronically signed; and
representing the location where the dynamic electronic document is to be signed in a format providing sufficient information to permit proper placement of an electronic signature image at the location where the dynamic electronic document is to be electronically signed.

2. A method as recited in claim 1, wherein the information to permit proper placement of the electronic signature comprises page and coordinate information.

3. A method as recited in claim 2, wherein the information to permit proper placement of the electronic signature further comprises signatory information.

4. A method as recited in claim 1, wherein representing the location where the dynamic electronic document is to be signed comprises:
creating an array of document signature information containing:
page number information;
coordinate information; and
signature type information; and
representing the information contained in the array as a portion of an extensible markup language (XML) string.

5. A method as recited in claim 4, wherein creating an array comprises creating a plurality of arrays, the plurality of arrays comprising a signature line information array, an initials line information array, and an exception information array.

6. A method as recited in claim 4, further comprising:
converting the dynamic electronic document into an XML-compatible format; and
adding the dynamic electronic document in the XML-compatible format to the XML string.

7. A method as recited in claim 6, wherein additional information is added to the XML string, the additional information being selected from the group of:
signatory-identifying information;
signature room information;
invitee information identifying invitees to be invited to view the dynamic electronic document.

8. A method as recited in claim 6, further comprising processing the XML string to retrieve the dynamic electronic document and interpret the information regarding proper placement of an electronic signature to determine the location where the dynamic electronic document is to be signed.

9. A method as recited in claim 8, further comprising:
providing the dynamic electronic document to a signatory for review;
receiving a selection from the signatory indicating an intent to sign the dynamic electronic document; and
placing an electronic signature image representing an electronic signature of the signatory at the location where the dynamic electronic document is to be signed.

10. A method as recited in claim 9, whereby the electronic signature image is placed on an appropriate signature line of the dynamic electronic document.

11. A method as recited in claim 1, wherein the location where the dynamic electronic document is to be signed is a first location, the method further comprising:
modifying the terms of the dynamic electronic document whereby the location where the dynamic electronic document is to be signed is changed from the first location to a second location that is a different location than the first location; and
repeating the steps of:
scanning the dynamic electronic document to locate document signature information representing the location where the dynamic electronic document is to be electronically signed; and
representing the location where the dynamic electronic document is to be signed in the format providing sufficient information to permit proper placement of an electronic signature image at the location where the dynamic electronic document is to be electronically signed.

12. A method as recited in claim 1, further comprising:
providing the dynamic electronic document to a signatory for review;
receiving a selection from the signatory indicating an intent to sign the dynamic electronic document; and
placing an electronic signature image representing an electronic signature of the signatory at the location where the dynamic electronic document is to be signed.

13. A method as recited in claim 12, whereby the electronic signature image is placed on an appropriate signature line of the dynamic electronic document.

14. A computer-readable medium storing computer program code for implementing a method for ensuring proper placement of electronic signatures in a dynamic electronically-signed document where placement of one or more signatures in the document changes based on changes of terms within the document, the method comprising:
creating a dynamic electronic document having variable document contents, the document including a signature location;
scanning the dynamic electronic document to locate document signature information representing a location where the dynamic electronic document is to be electronically signed;
representing the location where the dynamic electronic document is to be signed in a format providing sufficient information to permit proper placement of an electronic signature image at the location where the dynamic electronic document is to be electronically signed.

15. A computer-readable medium as recited in claim 14, wherein representing the location where the dynamic electronic document is to be signed comprises:
creating an array of document signature information containing:
page number information;
coordinate information; and
signature type information; and
representing the information contained in the array as a portion of an extensible markup language (XML) string.

16. A computer-readable medium as recited in claim 15, wherein the method further comprises:
converting the dynamic electronic document into an XML-compatible format; and
adding the dynamic electronic document in the XML-compatible format to the XML string.

17. A computer-readable medium as recited in claim 16, wherein the method further comprises processing the XML string to retrieve the dynamic electronic document and interpret the information regarding proper placement of an electronic signature to determine the location where the dynamic electronic document is to be signed.

18. A computer-readable medium as recited in claim 17, wherein the method further comprises:
providing the dynamic electronic document to a signatory for review;
receiving a selection from the signatory indicating an intent to sign the dynamic electronic document; and
placing an electronic signature image representing an electronic signature of the signatory at the location where the dynamic electronic document is to be signed.

19. A computer-readable medium as recited in claim 18, whereby the electronic signature image is placed on an appropriate signature line of the dynamic electronic document.

20. A computer-readable medium as recited in claim 14, wherein the location where the dynamic electronic document is to be signed is a first location, the method further comprising:
modifying the terms of the dynamic electronic document whereby the location where the dynamic electronic document is to be signed is changed from the first location to a second location that is a different location than the first location; and
repeating the steps of:
scanning the dynamic electronic document to locate document signature information representing the location where the dynamic electronic document is to be electronically signed; and
representing the location where the dynamic electronic document is to be signed in the format providing sufficient information to permit proper placement of an electronic signature image at the location where the dynamic electronic document is to be electronically signed.
